(19) United States
(12) Patent Application Publication
(10) Pub. No.: US 2011/0221755 A1
(43) Pub. Date: Sep. 15, 2011

(54) BIONIC MOTION

(76) Inventors: Kevin Geisner, Mercer Island, CA (US); Relja Markovic, Seattle, WA (US); Stephen G. Latta, Seattle, WA (US); Brian James Mount, Seattle, WA (US); Zachary T. Middleton, Seattle, WA (US); Joel Deaguero, Snohomish, WA (US); Christopher Willoughby, Kirkland, WA (US); Dan Osborn, Redmond, WA (US); Darren Bennett, Seattle, WA (US); Gregory N. Snook, Sammamish, WA (US)

(21) Appl. No.: 12/722,587

(22) Filed: Mar. 12, 2010

(51) Int. Cl. G09G 5/00; G06T 13/00

(52) U.S. Cl. 345/474; 345/156

(57) ABSTRACT

A camera that can sense motion of a user is connected to a computing system (e.g., video game apparatus or other type of computer). The computing system determines an action corresponding to the sensed motion of the user and determines a magnitude of the sensed motion of the user. The computing system creates and displays an animation of an object (e.g., an avatar in a video game) performing the action in a manner that is amplified in comparison to the sensed motion by a factor that is proportional to the determined magnitude. The computing system also creates and outputs audio/visual feedback in proportion to a magnitude of the sensed motion of the user.

### BACKGROUND

Many computing applications such as computer games, multimedia applications, or the like use controls to allow users to manipulate game characters or other aspects of an application. Typically such controls are input using, for example, controllers, remotes, keyboards, mice, or the like. Unfortunately, such controls can be difficult to learn, thus creating a barrier between a user and such games and applications. Furthermore, such controls may be different than actual game actions or other application actions for which the controls are used. For example, a game control that causes a game character to swing a baseball bat may not correspond to an actual motion of swinging the baseball bat.

### SUMMARY

Disclosed herein are systems and methods for tracking motion of a user or other objects. The tracked motion is then used to update an application. For example, a user can manipulate avatars or other aspects of the application by using movement of the user's body and/or objects around the user, rather than (or in addition to) using controllers, remotes, keyboards, mice, or the like. Technology is provided that can amplify the user's motion in the virtual world to create a more compelling experience. For example, a small jump by a user can translate to a very high jump by an avatar in a virtual world game.

One embodiment includes using a camera to sense motion of a user. In response to sensing the motion of the user, the system creates and displays an animation of an object performing the motion of the user in a manner that is amplified in comparison to the motion of the user. The system creates and outputs audio/visual feedback in proportion to a magnitude of the sensed motion of the user.

One embodiment includes a camera that can sense motion of a user and a computer connected to the camera to receive data from the camera. The data indicates the motion of the user. The computer determines an action corresponding to the sensed motion of the user and determines a magnitude of the sensed motion of the user. The computer creates and displays an animation of an avatar in a video game performing the action in a manner that is amplified in comparison to the sensed motion. The action is amplified by a factor that is proportional to the determined magnitude of the sensed motion of the user.

One embodiment includes one or more processor readable storage devices having processor readable code embodied on the one or more processor readable storage devices. The processor readable code programs one or more processors to perform a method that comprises receiving data from a camera that indicates motion of a user, determining an action corresponding to the motion of the user indicated by the received data (including determining the start of the action by the user and determining the end of the action by the user), and creating and displaying an animation of an object in an application performing the action in a manner that is amplified in comparison to the sensed motion of the user such that the object starts the action at the start of the action by the user and the object ends the action at the end of the action by the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B illustrate an example embodiment of a tracking system with a user playing a game.

FIG. 2 illustrates an example embodiment of a capture device that may be used as part of the tracking system.

FIG. 3 depicts an example of a skeleton.

FIG. 4 illustrates an example embodiment of a computing system that may be used to track motion and update an application based on the tracked motion.

FIG. 5 illustrates another example embodiment of a computing system that may be used to track motion and update an application based on the tracked motion.

FIG. 6 is a flow chart describing one embodiment of a process for interacting with a computer based application, including amplifying motion to create bionic motion in the application.

FIG. 7 is a flow chart describing one embodiment of a process for determining whether an action by a user can be amplified.

FIG. 8 is a flow chart describing one embodiment of a process for determining whether amplification of user motion is appropriate with respect to the current context of an application.

FIG. 9 is a flow chart describing one embodiment of a process for creating an animation that shows amplified motion.

FIG. 10 graphically depicts one example of determining a scaling factor for creating amplified motion.

FIG. 11 is a flow chart describing one embodiment of a process for drawing an avatar performing the amplified motion.

### DETAILED DESCRIPTION

A video game system (or other data processing system) tracks users and objects using depth images and/or visual images. The tracking is then used to update an application (e.g., a video game). Therefore, a user can manipulate game characters or other aspects of the application by using movement of the user's body and/or objects around the user, rather than (or in addition to) using controllers, remotes, keyboards, mice, or the like. For example, a user's motions can be used to drive the movement of an avatar in a virtual world. The avatar will perform the same (or similar) actions as the user.

In some situations, the avatar will perform the action that the user is performing; however, the avatar will perform that action in a manner that is amplified in comparison to the motion of the user. For example, an avatar will jump significantly higher than the user jumps, duck much lower than the user ducks, throw much harder than the user throws, etc. The amplification can be by a factor that is proportional to the determined magnitude of the user. For example, the faster that the user jumps, the higher that the avatar will jump. The video game system will also create and output audio/visual feedback in proportion to a magnitude of the motion of the user.

Although the examples below include a video game system, the technology described herein also applies to other types of data processing systems and/or other types of applications.

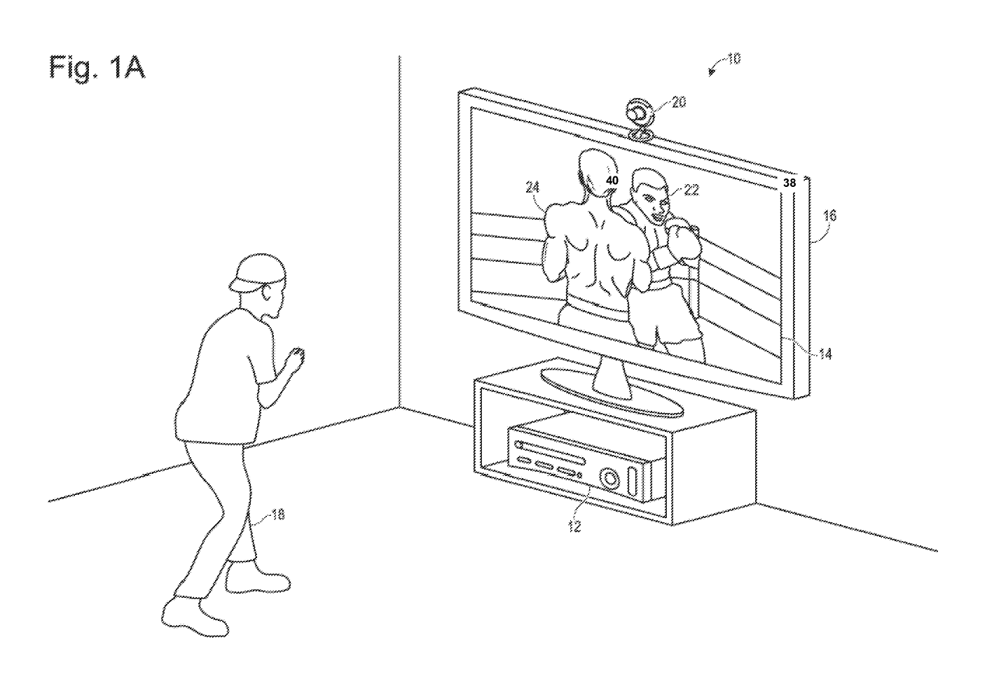

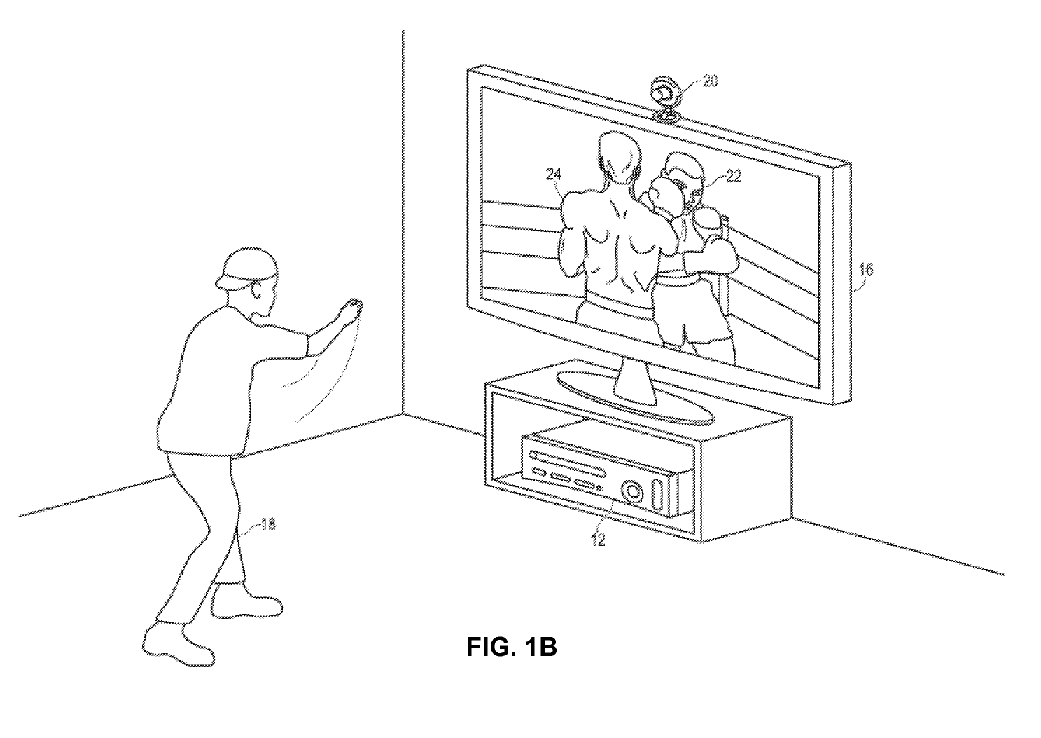

FIGS. 1A and 1B illustrate an example embodiment of a system 10 with a user 18 playing a boxing game. In an example embodiment, the system 10 may be used to recognize, analyze, and/or track a human target such as the user 18 or other objects within range of tracking system 10.

As shown in FIG. 1A, tracking system 10 may include a computing system 12. The computing system 12 may be a computer, a gaming system or console, or the like. According to an example embodiment, the computing system 12 may include hardware components and/or software components such that computing system 12 may be used to execute applications such as gaming applications, non-gaming applications, or the like. In one embodiment, computing system 12 may include a processor such as a standardized processor, a specialized processor, a microprocessor, or the like that may execute instructions stored on a processor readable storage device for performing the processes described herein.

As shown in FIG. 1A, tracking system 10 may further include a capture device 20. The capture device 20 may be, for example, a camera that may be used to visually monitor one or more users, such as the user 18, such that gestures and/or movements performed by the one or more users may be captured, analyzed, and tracked to perform one or more controls or actions within the application and/or animate an avatar or on-screen character, as will be described in more detail below.

According to one embodiment, the tracking system 10 may be connected to an audiovisual device 16 such as a television, a monitor, a high-definition television (HDTV), or the like that may provide game or application visuals and/or audio to a user such as the user 18. For example, the computing system 12 may include a video adapter such as a graphics card and/or an audio adapter such as a sound card that may provide audiovisual signals associated with the game application, non-game application, or the like. The audiovisual device 16 may receive the audiovisual signals from the computing system 12 and may then output the game or application visuals and/or audio associated with the audiovisual signals to the user 18. According to one embodiment, the audiovisual device 16 may be connected to the computing system 12 via, for example, an S-Video cable, a coaxial cable, an HDMI cable, a DVI cable, a VGA cable, component video cable, or the like.

As shown in FIGS. 1A and 1B, the tracking system 10 may be used to recognize, analyze, and/or track a human target such as the user 18. For example, the user 18 may be tracked using the capture device 20 such that the gestures and/or movements of user 18 may be captured to animate an avatar or on-screen character and/or may be interpreted as controls that may be used to affect the application being executed by computer environment 12. Thus, according to one embodiment, the user 18 may move his or her body to control the application and/or animate the avatar or on-screen character.

In the example depicted in FIGS. 1A and 1B, the application executing on the computing system 12 may be a boxing game that the user 18 is playing. For example, the computing system 12 may use the audiovisual device 16 to provide a visual representation of a boxing opponent 22 to the user 18. The computing system 12 may also use the audiovisual device 16 to provide a visual representation of a user avatar 24 that the user 18 may control with his or her movements. For example, as shown in FIG. 1B, the user 18 may throw a punch in physical space to cause the user avatar 24 to throw a punch in game space. Thus, according to an example embodiment, the computer system 12 and the capture device 20 recognize and analyze the punch of the user 18 in physical space such that the punch may be interpreted as a game control of the user avatar 24 in game space and/or the motion of the punch may be used to animate the user avatar 24 in game space.

Other movements by the user 18 may also be interpreted as other controls or actions and/or used to animate the user avatar, such as controls to bob, weave, shuffle, block, jab, or throw a variety of different power punches. Furthermore, some movements may be interpreted as controls that may correspond to actions other than controlling the user avatar 24. For example, in one embodiment, the user may use movements to end, pause, or save a game, select a level, view high scores, communicate with a friend, etc. According to another embodiment, the user may use movements to select the game or other application from a main user interface. Thus, in example embodiments, a full range of motion of the user 18 may be available, used, and analyzed in any suitable manner to interact with an application.

In example embodiments, the human target such as the user 18 may have an object. In such embodiments, the user of an electronic game may be holding the object such that the motions of the user and the object may be used to adjust and/or control parameters of the game. For example, the motion of a user holding a racket may be tracked and utilized for controlling an on-screen racket in an electronic sports game. In another example embodiment, the motion of a user holding an object may be tracked and utilized for controlling an on-screen weapon in an electronic combat game. Objects not held by the user can also be tracked, such as objects thrown, pushed or rolled by the user (or a different user) as well as self propelled objects. In addition to boxing, other games can also be implemented.

According to other example embodiments, the tracking system 10 may further be used to interpret target movements as operating system and/or application controls that are outside the realm of games. For example, virtually any controllable aspect of an operating system and/or application may be controlled by movements of the target such as the user 18.

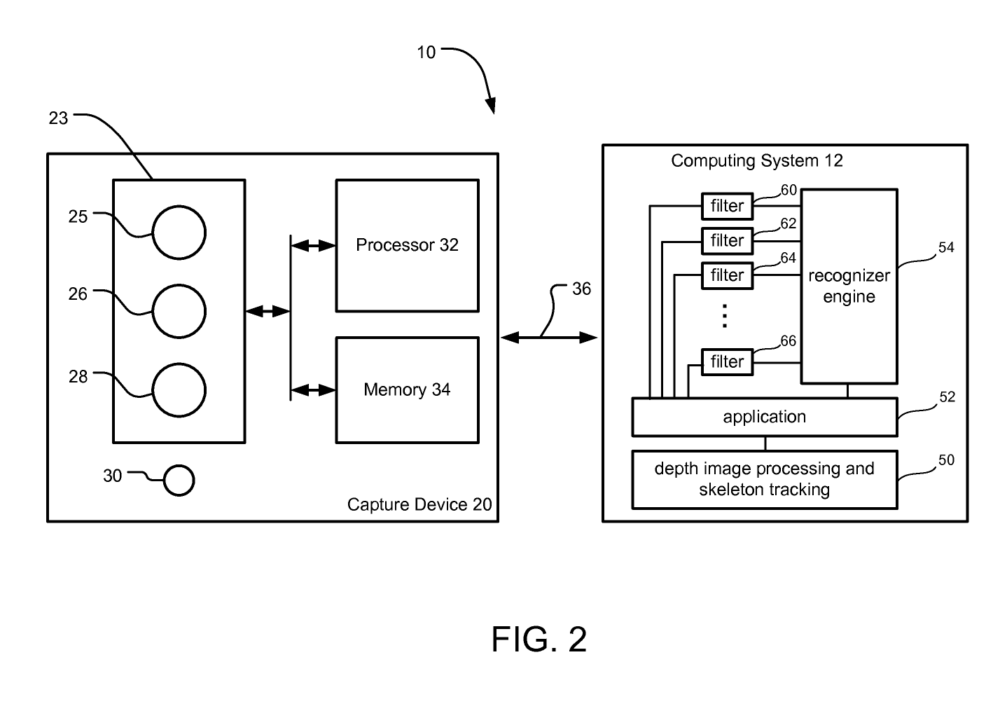

FIG. 2 illustrates an example embodiment of the capture device 20 that may be used in the tracking system 10. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 2, the capture device 20 may include a camera component 23. According to an example embodiment, the camera component 23 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 2, according to an example embodiment, the image camera component 23 may include an infra-red (IR) light component 25, a three-dimensional (3-D) camera 26, and an RGB (visual image) camera 28 that may be used to capture the depth image of a scene. For example, in time-of-flight analysis, the IR light component 25 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as grid pattern, a stripe pattern, or different pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 (and/or other sensor) and may then be analyzed to determine a physical distance from the capture device to a particular location on the targets or objects. In some implementations, the IR Light component 25 is displaced from the cameras 25 and 26 so triangulation can be used to determined distance from cameras 25 and 26. In some implementations, the capture device 20 will include a dedicated IR sensor to sense the IR light, or a sensor with an IR filter.

According to another embodiment, the capture device 20 may include two or more physically separated cameras that may view a scene from different angles to obtain visual stereo data that may be resolved to generate depth information. Other types of depth image sensors can also be used to create a depth image.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing system 12 in the target recognition, analysis, and tracking system 10. Additionally, the microphone 30 may be used to receive audio signals that may also be provided by to computing system 12.

In an example embodiment, the capture device 20 may further include a processor 32 that may be in communication with the image camera component 22. The processor 32 may include a standardized processor, a specialized processor, a microprocessor, or the like that may execute instructions including, for example, instructions for receiving a depth image, generating the appropriate data format (e.g., frame) and transmitting the data to computing system 12.

The capture device 20 may further include a memory component 34 that may store the instructions that are executed by processor 32, images or frames of images captured by the 3-D camera and/or RGB camera, or any other suitable information, images, or the like. According to an example embodiment, the memory component 34 may include random access memory (RAM), read only memory (ROM), cache, flash memory, a hard disk, or any other suitable storage component. As shown in FIG. 2, in one embodiment, memory component 34 may be a separate component in communication with the image capture component 22 and the processor 32. According to another embodiment, the memory component 34 may be integrated into processor 32 and/or the image capture component 22.

As shown in FIG. 2, capture device 20 may be in communication with the computing system 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing system 12 may provide a clock to the capture device 20 that may be used to determine when to capture, for example, a scene via the communication link 36. Additionally, the capture device 20 provides the depth information and visual (e.g., RGB) images captured by, for example, the 3-D camera 26 and/or the RGB camera 28 to the computing system 12 via the communication link 36. In one embodiment, the depth images and visual images are transmitted at 30 frames per second. The computing system 12 may then use the model, depth information, and captured images to, for example, control an application such as a game or word processor and/or animate an avatar or on-screen character.

Computing system 12 includes depth image processing and skeletal tracking module 50, which uses the depth images to track one or more persons detectable by the depth camera. Depth image processing and skeletal tracking module 50 provides the tracking information to application 196, which can be a video game, productivity application, communications application or other software application etc. The audio data and visual image data is also provided to application 52 and depth image processing and skeletal tracking module 50. Application 52 provides the tracking information, audio data and visual image data to recognizer engine 54. In another embodiment, recognizer engine 54 receives the tracking information directly from depth image processing and skeletal tracking module 50 and receives the audio data and visual image data directly from capture device 20.

Recognizer engine 54 is associated with a collection of filters 60, 62, 64, . . . , 66 each comprising information concerning a gesture, action or condition that may be performed by any person or object detectable by capture device 20. For example, the data from capture device 20 may be processed by filters 60, 62, 64, . . . , 66 to identify when a user or group of users has performed one or more gestures or other actions. Those gestures may be associated with various controls, objects or conditions of application 52. Thus, the computing environment 12 may use the recognizer engine 54, with the filters, to interpret movements.

Capture device 20 of FIG. 2 provides RGB images (or visual images in other formats or color spaces) and depth images to computing system 12. The depth image may be a plurality of observed pixels where each observed pixel has an observed depth value. For example, the depth image may include a two-dimensional (2-D) pixel area of the captured scene where each pixel in the 2-D pixel area may have a depth value such as distance of an object in the captured scene from the capture device.

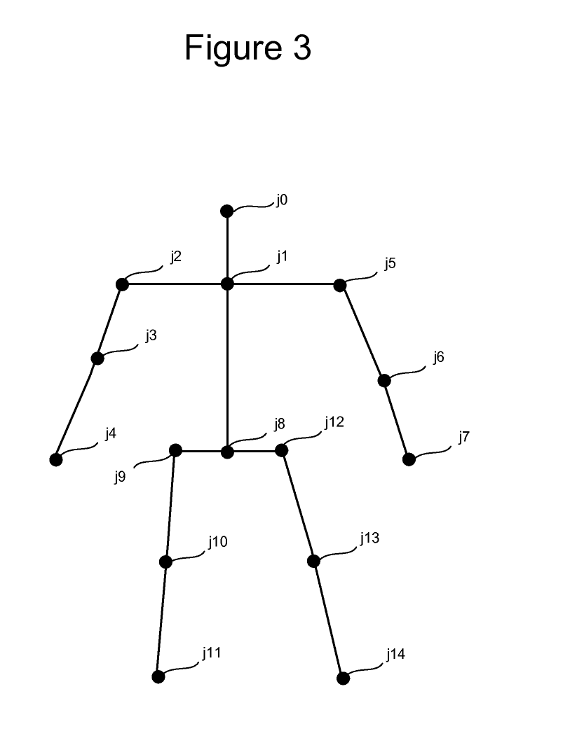

The system will use the RGB images and depth images to track a user's movements. For example, the system will track a skeleton of a person using the depth images. There are many methods that can be used to track the skeleton of a person using depth images. One suitable example of tracking a skeleton using depth image is provided in U.S. patent application Ser. No. 12/603,437, “Pose Tracking Pipeline” filed on Oct. 21, 2009, Craig, et al. (hereinafter referred to as the '437 Application), incorporated herein by reference in its entirety. The process of the '437 Application includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a set of joints and connections between the joints. FIG. 3 shows an example skeleton with 15 joints (j0, j1, j2, j3, j4, j5, j6, j7, j8, j9, j10, j11, j12, j13, and j14). Each of the joints represents a place in the skeleton where the skeleton can pivot in the x, y, z directions or a place of interest on the body. Other methods for tracking can also be used. Suitable tracking technology is also disclosed in the following four U.S. Patent Applications, all of which are incorporated herein by reference in their entirety: U.S. patent application Ser. No. 12/475,308, “Device for Identifying and Tracking Multiple Humans Over Time,” filed on May 29, 2009; U.S. patent application Ser. No. 12/696,282, “Visual Based Identity Tracking,” filed on Jan. 29, 2010; U.S. patent application Ser. No. 12/641,788, “Motion Detection Using Depth Images,” filed on Dec. 18, 2009; and U.S. patent application Ser. No. 12/575,388, “Human Tracking System,” filed on Oct. 7, 2009.

Recognizer engine 54 (of computing system 12 depicted in FIG. 2) includes multiple filters 60, 62, 64, . . . , 66 to determine a gesture or action. A filter comprises information defining a gesture, action or condition along with parameters, or metadata, for that gesture, action or condition. For instance, a throw, which comprises motion of one of the hands from behind the rear of the body to past the front of the body, may be implemented as a gesture comprising information representing the movement of one of the hands of the user from behind the rear of the body to past the front of the body, as that movement would be captured by the depth camera. Parameters may then be set for that gesture. Where the gesture is a throw, a parameter may be a threshold velocity that the hand has to reach, a distance the hand must travel (either absolute, or relative to the size of the user as a whole), and a confidence rating by the recognizer engine that the gesture occurred. These parameters for the gesture may vary between applications, between contexts of a single application, or within one context of one application over time.

Filters may be modular or interchangeable. In one embodiment, a filter has a number of inputs (each of those inputs having a type) and a number of outputs (each of those outputs having a type). A first filter may be replaced with a second filter that has the same number and types of inputs and outputs as the first filter without altering any other aspect of the recognizer engine architecture. For instance, there may be a first filter for driving that takes as input skeletal data and outputs a confidence that the gesture associated with the filter is occurring and an angle of steering. Where one wishes to substitute this first driving filter with a second driving filter—perhaps because the second driving filter is more efficient and requires fewer processing resources—one may do so by simply replacing the first filter with the second filter so long as the second filter has those same inputs and outputs—one input of skeletal data type, and two outputs of confidence type and angle type.

A filter need not have a parameter. For instance, a “user height” filter that returns the user's height may not allow for any parameters that may be tuned. An alternate “user height” filter may have tunable parameters—such as to whether to account for a user's footwear, hairstyle, headwear and posture in determining the user's height.

Inputs to a filter may comprise things such as joint data about a user's joint position, angles formed by the bones that meet at the joint, RGB color data from the scene, and the rate of change of an aspect of the user. Outputs from a filter may comprise things such as the confidence that a given gesture is being made, the speed at which a gesture motion is made, and a time at which a gesture motion is made.

The recognizer engine 54 may have a base recognizer engine that provides functionality to the filters. In one embodiment, the functionality that the recognizer engine 54 implements includes an input-over-time archive that tracks recognized gestures and other input, a Hidden Markov Model implementation (where the modeled system is assumed to be a Markov process—one where a present state encapsulates any past state information necessary to determine a future state, so no other past state information must be maintained for this purpose—with unknown parameters, and hidden parameters are determined from the observable data), as well as other functionality required to solve particular instances of gesture recognition.

Filters 60, 62, 64, . . . , 66 are loaded and implemented on top of the recognizer engine 54 and can utilize services provided by recognizer engine 54 to all filters 60, 62, 64, . . . , 66. In one embodiment, recognizer engine 54 receives data to determine whether it meets the requirements of any filter 60, 62, 64, . . . , 66. Since these provided services, such as parsing the input, are provided once by recognizer engine 54 rather than by each filter 60, 62, 64, . . . , 66, such a service need only be processed once in a period of time as opposed to once per filter for that period, so the processing required to determine gestures is reduced.

Application 52 may use the filters 60, 62, 64, . . . , 66 provided with the recognizer engine 54, or it may provide its own filter, which plugs in to recognizer engine 54. In one embodiment, all filters have a common interface to enable this plug-in characteristic. Further, all filters may utilize parameters, so a single gesture tool below may be used to debug and tune the entire filter system.

More information about recognizer engine 54 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009. both of which are incorporated herein by reference in their entirety.

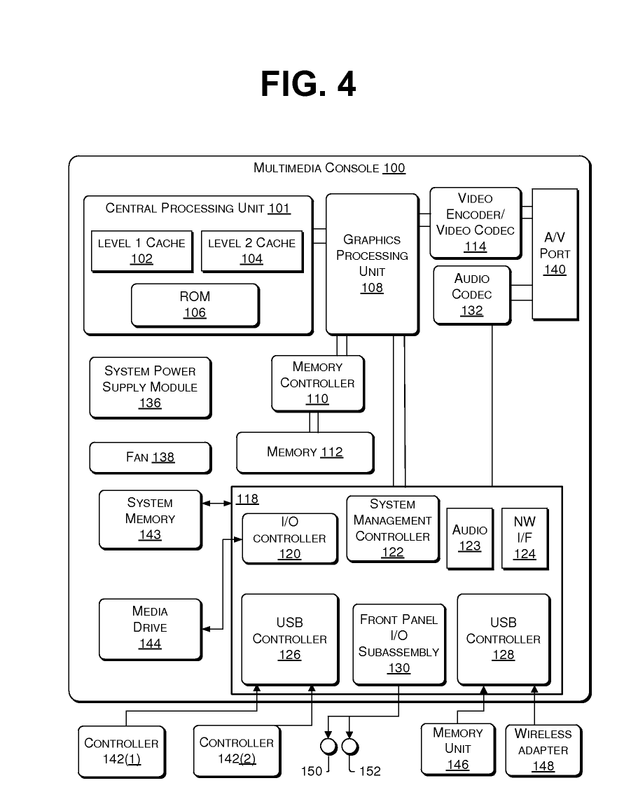

FIG. 4 illustrates an example embodiment of a computing system that may be the computing system 12 shown in FIGS. 1A-2 used to track motion and/or animate (or otherwise update) an avatar or other on-screen object displayed by an application. The computing system such as the computing system 12 described above with respect to FIGS. 1A-2 may be a multimedia console 100, such as a gaming console. As shown in FIG. 4, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered on.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, Blu-Ray drive, hard disk drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio user or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered on, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 26, 28 and capture device 20 may define additional input devices for the console 100 via USB controller 126 or other interface.

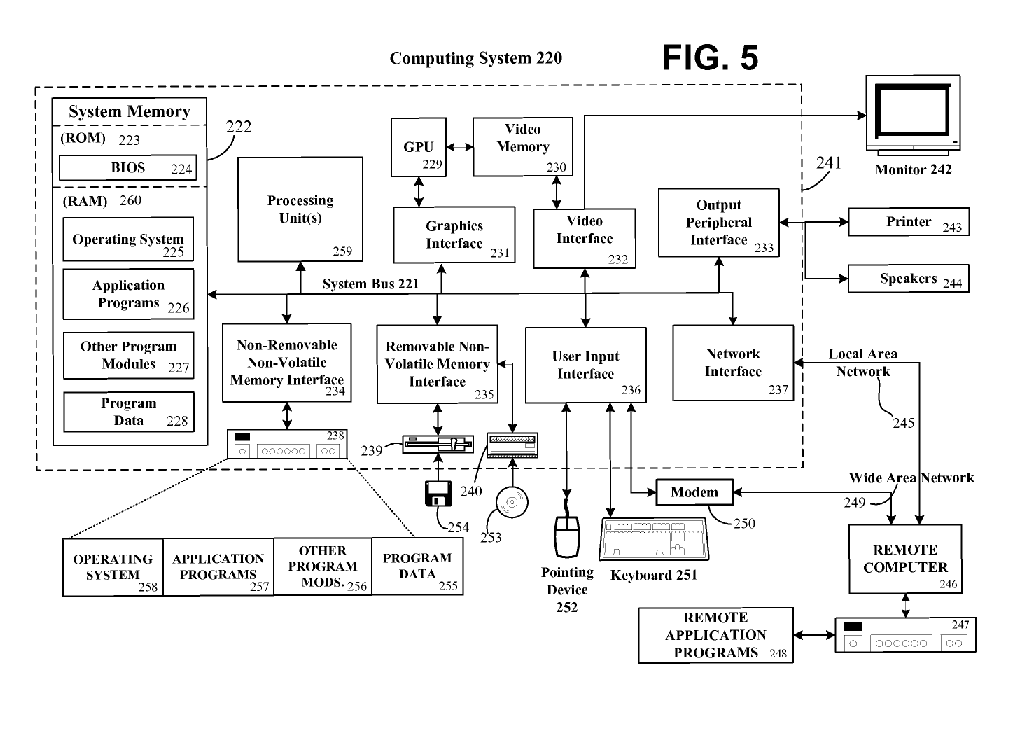

FIG. 5 illustrates another example embodiment of a computing system 220 that may be used to implement the computing system 12 shown in FIGS. 1A-2 used to track motion and/or animate (or otherwise update) an avatar or other on-screen object displayed by an application. The computing system environment 220 is only one example of a suitable computing system and is not intended to suggest any limitation as to the scope of use or functionality of the presently disclosed subject matter. Neither should the computing system 220 be interpreted as having any dependency or requirement relating to any one or combination of components illustrated in the exemplary operating system 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computing system 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 5, provide storage of computer readable instructions, data structures, program modules and other data for the computer 241. In FIG. 5, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100 that connect via user input interface 236. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233. Capture Device 20 may connect to computing system 220 via output peripheral interface 233, network interface 237, or other interface.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 5. The logical connections depicted include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 5 illustrates application programs 248 as residing on memory device 247. It will be appreciated that the network connections shown are exemplary and other means of establishing a communications link between the computers may be used.

Either of the systems of FIG. 4 or 5, or a different computing system, can be used to implement Computing System 12 of FIG. 2. As explained above, computing system 12 determines the motions of the users and employs those detected motions to control a video game or other application. For example, a user's motions can be used to control an avatar and/or object in a video game. In some embodiments, the system can simultaneously track multiple users and allow the motion of multiple users to control the application.

The above-described video game systems will track users and objects using depth images and/or visual images. The tracking is then used to update the application (e.g., a video game). Therefore, a user can manipulate game characters or other aspects of the application by using movement of the user's body and/or objects around the user. For example, a user's motions can be used to drive the movement of an avatar in a virtual world. The avatar will perform the same (or similar) actions as the user. In some situations, the avatar will perform the action that the user is performing; however, the avatar will perform that action in a manner that is amplified in comparison to the motion of the user.

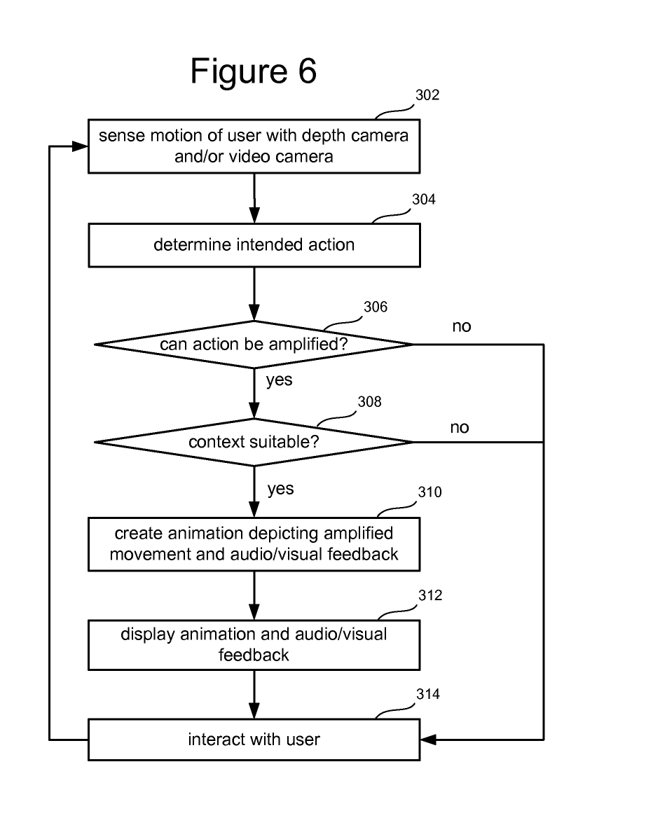

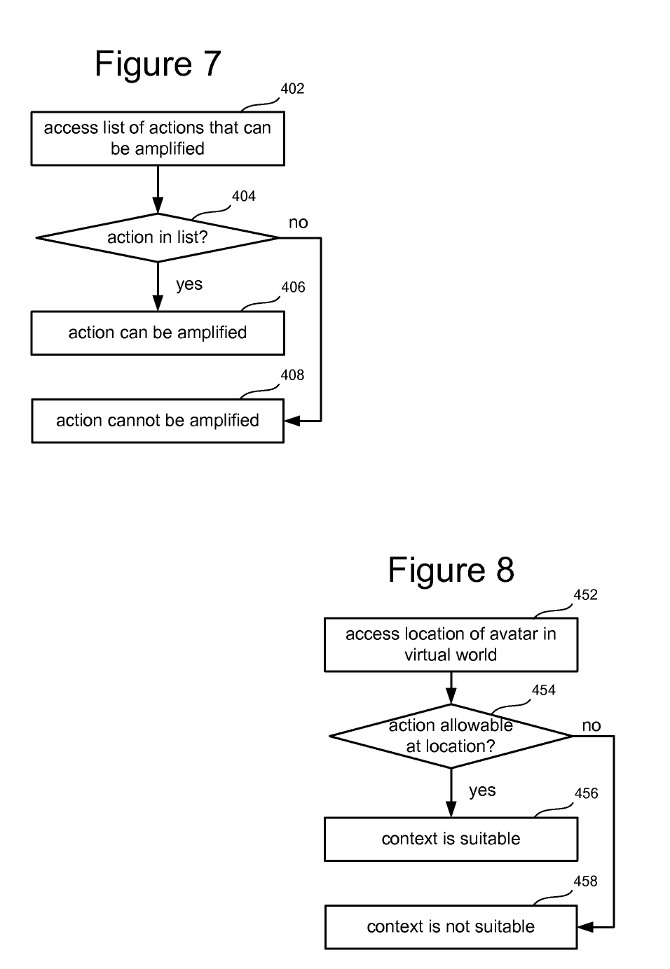

FIG. 6 is a flow chart describing one embodiment of a process for providing amplified motion during interaction between a user and application. In the discussion below, a video game will be used as an example of an application. However, the process of FIG. 6 (as well as FIGS. 7-11) also applies to other types of applications. In step 302 of FIG. 6, the system will sense motion of the user using a depth camera and/or video camera (as described above). In step 304, the system will determine an intended action. For example, the system will recognize the start of a gesture or the start of a predefined action. An example of a predefined action is a jump or a duck. Other actions can also be included. In one embodiment, the skeleton is tracked, as described above, in order to identify the motion of certain joints indicative of a jump or duck or other action. In some embodiments, the system will not be able to determine intended action from the motion sent. In one embodiment, the system recognizes/determines the actions of the user by employing using the filters 60, 62, 64, . . . , 66, in conjunction with recognizer engine 54 (see FIG. 2), as discussed above.

In step 306, the system determines whether the intended action is an action that can be amplified. The system will be configured so that some actions can be amplified and other actions cannot be amplified. In one embodiment, only jumps and ducks are amplified. In another embodiments, only jumps, ducks, arm swings, punches, and throws are amplified. In other embodiments, other sets of actions can be amplified.

If the intended action is not an action that can be amplified, the system will interact with the user without amplifying any action in step 314. If the intended action is an action that can be amplified, then in step 308 it is determined whether the context of the application is suitable for amplification. For example, the system will determine, based on the context of the video game being played, whether it is appropriate to amplify the action. For example, if an avatar in a video game is in a cave or room with a very low ceiling and the user performs a jump, it would not be appropriate to amplify the jump. If the context of the application is not suitable for amplification, then the application will interact with the user (step 314) without amplification of the user's actions. However, if the context is suitable for amplification of the user's action, then in step 310 the system will create an animation depicting the avatar performing the same movement as the user; however, the avatar's movement will be amplified in comparison to the user, all in response to sensing the motion of the user. In one embodiment, the amount of amplification of the user's actions will be by a factor that is proportional to the magnitude of the user's motions, which will be described below. Additionally, in one embodiment, the animation will be created to synchronize with the user's movements so that the avatar will start and stop the animation at the same time that the user starts and stops the user's movements. Additionally, in step 312, the system will provide audio/visual feedback to the user in proportion to the magnitude of the sensed motion of the user. For purposes of this document, “audio/visual” includes audio only, visual only, or a combination of audio and visual. In step 314, the system will continue to interact with the user. The process of FIG. 6 can be continuously repeated.

Although FIG. 6 shows steps in sequential order, the steps can be performed in a different order. Additionally, and likely, the system will perform many of these steps concurrently. For example, in step 314, the application interacting with the user, can occur while other steps 302-312 are being performed. In one embodiment, interacting with the user, step 314, is performed during the entire time that FIG. 6 is being performed. In some embodiments, the motion sensing of step 302 is performed continuously and, when an intended action is determined, steps 302-312 can be performed. Additionally, steps 310 and 312 can be performed concurrently so that the animation is created and displayed in real time. Additionally, steps 310-312 can be performed concurrently with sensing the corresponding motion of the user (step 302) so that the animation is displayed in synchronization with the movement of the user.

FIG. 7 is a flow chart describing one embodiment of a process for determining whether a particular action can be amplified. The process of FIG. 7 is one example implementation of step 306 of FIG. 6. In step 402, the system will access a list of actions that can be amplified. In one embodiment, the creator of the particular application will provide a predefined list of actions that may be amplified. In another embodiment, each action that can be amplified is associated with a filter (see filters 60, 52, 64, . . . , 66 of FIG. 2) so that step 402 will include accessing a list of the filters. In step 404,the application will determine whether the action intended by the user is on the list of actions that can be amplified. If so, then it is concluded that the particular action of the user can be amplified (step 406); otherwise, the action intended by the user cannot be amplified (step 408).

FIG. 8 is a flow chart describing one embodiment of a process for determining whether the current context of the application is suitable for amplification. The process of FIG. 8 is one example implementation of step 308 of FIG. 6. In step 452 of FIG. 8, the application will access the location of the avatar in the virtual world. In step 454, the application will determine whether an amplified version of the action intended by the user is allowable at the current location. If so, then the context is suitable for amplification (step 456); otherwise, the context is not suitable for amplification (step 458).

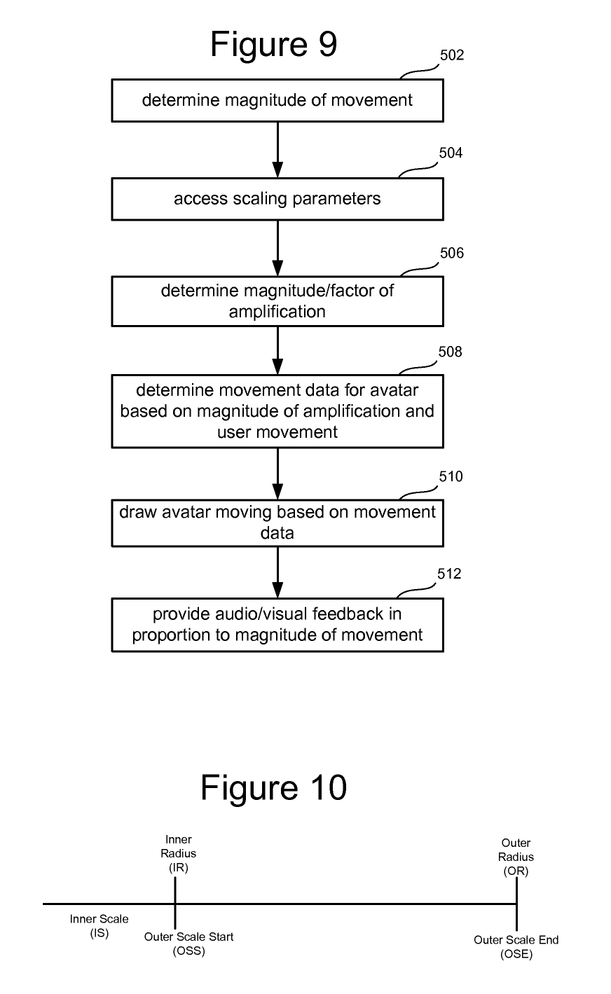

FIG. 9 is a flow chart describing one embodiment of a process for creating an animation depicting the amplified movement and audio/visual feedback. The process of FIG. 9 is one example implementation of step 310 of FIG. 6. In step 502 of FIG. 9, the system will determine the magnitude of movement. In one embodiment, step 502 includes determining velocity, speed, acceleration, distance and/or timing information. In one example, the system will determine the amount of units of distance moved by the user during a period of time P. In one example, P could be one second; however, other time periods can be used. The units of distance can be in meters, centimeters, inches, etc.

In step 504, the system will access scaling parameters. For example, the system will employ a number to be used as a multiplier to create the amplification of movement for the avatar corresponding to the user's movement. In one embodiment, the multiplier can be a integer. In other embodiments, more complex mathematical functions can be used to identify the appropriate multiplier. The multiplier can be based on the magnitude of movement of the user, context of the application and/or other environmental conditions. In one embodiment, the system will store a set of multipliers or a mathematical equation/relationship to be evaluated. The set of set of multipliers or mathematical equation/relationship are accessed in step 504. Step 506 includes determining the magnitude of amplification from the set of multipliers or mathematical equation/relationship accessed in step 504.

FIG. 10 graphically depicts one example of a system for determining a scaling parameter to be used as a multiplier to create the amplification. In the embodiment of FIG. 10, the system will include an inner radius IR and an outer radius OR, both of which are distance values. If the amount of distance the user moves (e.g., the amount the hip joint j9 moves upward during a jump) in the time period P is less than the inner radius IR, then the avatar's movement will be created to be the user's movement multiplied by inner scaling parameter IS. The inner radius IR is also associated with an outer scaling parameter start value OSS. The outer radius OR is associated with an outer scaling parameter end value OSE. If the amount of distance the user moves in the time period P is equal to the inner radius IR, then the avatar's movement will be created to be the user's movement multiplied by outer scaling parameter start value OSS. If the amount of distance the user moves in the time period P is equal to the outer radius OR, then the avatar's movement will be created to be the user's movement multiplied by outer scaling parameter end value OSE. If the amount of distance the user moves in the time period P is between IR and OR, then a scaling factor between OSS and OSE will be used to amplify the user's distance when creating the avatar's movement by interpolating between OSS and OSE based on how the distance D the user moves in the time period P is between IR and OR. The following equation can be used:

$$Magnitude of amplification = OSS + ( OSE - OSS ) ( \frac{D - IR}{OR - IR} )$$

In step 508, the system will determine the movement data for the avatar based on the magnitude of amplification determined in step 506 and the user's movement which was sensed in step 302 of FIG. 6. In step 510, the system will draw the avatar moving based on the movement data determined in step 508. The avatar's movement will be amplified in comparison to the sensed motion of the user by a factor that is proportional to the determined magnitude of the user's movement.

In step 512, the system will provide audio/visual feedback in proportion to the magnitude of movement. In one embodiment, the system will make sounds with the pitch or tone of the sound varying based on the determined magnitude/factor of amplification in step 506, which is itself based on the magnitude of movement of the user. In other embodiments, the system can provide visual feedback at the beginning, during or end of the action. For example, if the user jumps and the avatar makes a higher jump, when the avatar lands the ground can shake in proportion to the magnitude/factor of amplification. Alternatively, the avatar's hair can blow in the wind, where the wind has speed based on the magnitude/factor of amplification. Other examples of audio/visual feedback include a cloud at the top of a jump, ducks flying at takeoff of the jump, a thud at landing, footprints where the jumper took off, etc. Any of these visual feedbacks can be varied based on the magnitude/factor of amplification. For example, change the amount of dust flying, change the size of the crowd, change the volume/pitch/tone of the thud at landing, and/or change the size of the footprints.

Although FIG. 9 shows the steps in a particular order, those steps of FIG. 9 can be performed in other orders than as depicted. In addition, many of the steps of FIG. 9 can be performed concurrently. For example, in one embodiment, determining movement data (step 508) and drawing the avatar (step 510) can be performed continuously, while the magnitude of amplification can be determined at the beginning of an action.

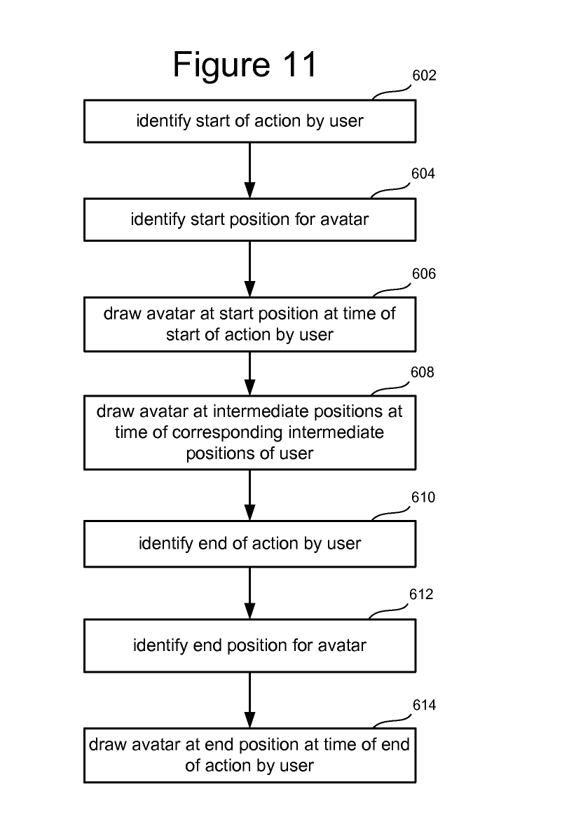

FIG. 11 is a flow chart describing one embodiment for drawing the avatar moving based on movement data. The process of FIG. 11 is one example implementation of step 510 of FIG. 9. In step 602 of FIG. 11, the system identifies the start of an action by the user. At this point in the process, the system has already determined the intended action by the user and thus the system knows the start of that action. The system will identify the start position of the avatar in step 604, based on the game context. In step 606, the system will draw the avatar at the start position at the time of the start of the action by the user or very close to that time. To perform the steps described above, there may be come delay between the start of the action by the user and when the avatar starts the action; however, this delay may be minimal and, possibly, not perceptible by a user. In step 608, the avatar will be drawn in intermediate positions for the action at times corresponding to intermediate positions of a user. In step 610, the system will identify the end of the action by the user. For example, the system will identify when the user has completed a jump by determining when the user has reached the ground. In step 612, the system will identify the end position for the avatar and then draw the avatar at that end position at the same time that the user ends the user's action (step 614). In one embodiment, the process of FIG. 11 is performed at the same time as the user is performing the action; therefore, the system will be sensing motion data for the user and performing the process of FIG. 11 concurrently.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method for providing amplified motion, comprising:
using a camera to sense motion of a user;
in response to sensing the motion of the user, creating and displaying an animation of an object performing the motion of the user in a manner that is amplified in comparison to the motion of the user; and
creating and outputting audio/visual feedback in proportion to a magnitude of the sensed motion of the user.

2. The method of claim 1, wherein:
the using a camera to sense motion includes using a depth camera to sense a depth image and determining the motion of the user from the depth image.

3. The method of claim 1, further comprising:
determining the magnitude of the sensed motion of the user, the motion of the user is amplified by a factor that is proportional to the magnitude of the sensed motion of the user.

4. The method of claim 1, wherein:
the creating and displaying the animation of an object performing the motion of the user includes creating and displaying the object starting the motion when the user starts the motion and completing the motion when the user completes the motion.

5. The method of claim 1, wherein:
the object is an avatar in a video game.

6. The method of claim 1, further comprising:
determining an intent of the user for performing the motion, the creating and displaying an animation is based on the determined intent.

7. The method of claim 1, wherein:
the object is an avatar in a video game; and
the method further comprises determining to amplify the motion of the user based on context of the avatar in the video game at the time of the motion of the user.

8. The method of claim 1, further comprising:
determining a gesture corresponding to the motion of the user, the animation of the object performing the motion of the user includes the object performing the gesture.

9. The method of claim 1, further comprising:
determining an action corresponding to the motion of the user, the animation of the object performing the motion of the user includes the object performing the action.

10. The method of claim 9, further comprising:
determining the magnitude of the sensed motion of the user, the motion of the user is amplified by a factor that is proportional to the determined magnitude of the sensed motion of the user, the using a camera to sense motion includes using a depth camera to sense a depth image and determining the motion of the user from the depth image, the object is an avatar in a video game.

11. A system that can provide amplified motion, comprising:
a camera that can sense motion of a user; and
a computer connected to the camera to receive data from the camera that indicates the motion of the user, the computer determines an action corresponding to the sensed motion of the user and determines a magnitude of the sensed motion of the user, the computer creates and displays an animation of an avatar in a video game performing the action in a manner that is amplified in comparison to the sensed motion by a factor that is proportional to the determined magnitude.

12. The system of claim 11, wherein:
the camera is a depth camera and the data from the camera includes a depth image.

13. The system of claim 11, wherein:
the action is a gesture; and
the animation of the avatar in the video game performing the action includes the avatar performing the gesture.

14. The system of claim 11, wherein:
the computer determines an intent of the user for performing the motion, the computer creates and displays the animation based on the determined intent.

15. The system of claim 11, wherein:
The magnitude of the sensed motion includes distance per time interval.

16. The system of claim 11, wherein:
the computer creates and displays an animation of an avatar in a video game performing the action such that the avatar starts the action at a start of the action by the user and the object ends the action at an end of the action by the user.

17. One or more processor readable storage devices having processor readable code embodied on said one or more processor readable storage devices, the processor readable code for programming one or more processors to perform a method comprising:
receiving data from a camera that indicates motion of a user;
determining an action corresponding to the motion of the user indicated by the received data, including determining the start of the action by the user and determining the end of the action by the user; and
creating and displaying an animation of an object in an application performing the action in a manner that is amplified in comparison to the sensed motion of the user such that the object starts the action at the start of the action by the user and the object ends the action at the end of the action by the user.

18. One or more processor readable storage devices according to claim 17, wherein:
receiving data from a camera that indicates motion of a user includes receiving a depth image from the camera.

19. One or more processor readable storage devices according to claim 17, wherein:
the object is an avatar in a video game;
the determining the action corresponding to the motion of the user includes recognizing a gesture; and
the animation of the object performing the action is an animation of the avatar performing the gesture in synchronization with the user.

20. One or more processor readable storage devices according to claim 19, further comprising:
providing visual feedback in proportion to velocity of the gesture by the user.
